(19) United States
(12) Patent Application Publication
(10) Pub. No.: US 2004/0060885 A1
(43) Pub. Date: Apr. 1, 2004

(54) Travelling working machine

(75) Inventor: Takahiro Hanamoto, Akashi-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KOBELCO CONSTRUCTION MACHINERY CO., LTD., Hiroshima-shi (JP)

(21) Appl. No.: 10/668,174

(22) Filed: Sep. 24, 2003

(30) Foreign Application Priority Data
Sep. 30, 2002 (JP) 2002-285726

(51) Int. Cl. B66C 23/26

(52) U.S. Cl. 212/175

(57) ABSTRACT

This invention provides with a travelling working machine comprising an upper rotating body with a rotating frame and winches, a pair of right and left boom support frames formed in the rotating frame, and axial portions of the winches mounted inside rear portions of the boom support frames, characterized in that the boom support frames have openings formed by being cut out along small-diameter portions of the winches than maximum-diameter portions thereof, thereby capable of providing with the travelling working machine having the rotating frame in such a manner that the strength of the frame can be enhanced and a load bearing force can be strengthened highly without enlarging a rear swing radius of the upper rotating body.

### BACKGROUND OF THE INVENTION

1. Field of the Invention

This invention relates to a travelling working machine with winches.

2. Description of the Related Art

FIG. 8 shows a telescopic boom type crane. An upper rotating body 52 is mounted rotatably on a lower travelling body 51 with crawlers 50. A telescopic boom is mounted on the upper rotating body 52 so as to be capable of rising and lowering. The reference numeral 54 is a cylinder for rising and lowering the boom 53.

A main winding rope 55a taken from a main winch 55 hangs up a main lifting hook 55b and an auxiliary rope 56a taken from an auxiliary winch 56 hangs up an auxiliary hook 56b, respectively.

As overhang of the boom in transport condition is too large, it is required to dispose the boom 53 and a boom supporting frame 52a as rearward as possible. In order to improve a workability or working efficiency at a limited space, it is required to make a rotating rear radius R (a distance from a rotating center to a rear end of the upper rotating body) of a crane like this as small as possible. Furthermore, a regulated transport condition limits a transverse width of the upper rotating body. As a result, there is not enough space on it to dispose the winches.

For saving the space, Japanese Patent Application Publication No. Hei 2001-316080 discloses a structure that, at a rearward portion (rear frame) of a boom supporting frame, winches are mounted in such a manner that two of them are disposed at left and right sides respectively of a lower portion of the frame and the other one is disposed at an upper portion thereof.

When the winches are disposed densely like this and a counterweight is mounted on a bracket at a rear frame with a sufficient strength has to be prepared so as to support load of the winches and the counterweight and so on.

In the meantime, when a winch with a transverse width which is longer than a width of a rear frame is used, it is necessary to form openings of the rear frame which have enough space for a flange, for example, as a maximum diameter-portion of the winch to pass through. Accordingly, the greater capacity of winding up the winch mounted on the rear frame has, the larger diameter the flange has. As a result, as the openings have to be larger in diameter according to the larger diameter, it is difficult to obtain a required strength of the rear frame.

### SUMMARY OF THE INVENTION

The present invention has an object to provide a travelling working machine with a rotating frame structure capable of withstanding a support of winches and a counterweight with a rear end swing radius smaller.

A travelling working machine of the present invention comprises a lower traveling body, an upper rotating body mounted rotatably on the lower traveling body, wherein the upper rotating body has a rotating frame and winches, a boom mounted on the upper rotating body so as to be capable of rising and lowering, and a pair of right and left boom support frames formed in the rotating frame to pivotally support both right and left sides of a rear end portion of the boom, wherein axial portions of the winches, including maximum-diameter portions of the winches, is mounted inside rear portions of the boom support frames and the boom support frames have openings formed by being cut out along smaller-diameter portions of the winches than the maximum-diameter portions.

The maximum-diameter portion of each of the winches indicates a portion with a maximum diameter among a flange of the winch drum. a brake device mounted on a side of the winch drum, and a portion of a decelerator mounted inside the rotating frame out of an outer periphery surface of the decelerator. In other words, it means a portion with a maximum outer diameter among mechanical elements (devices) disposed in a radial direction of the winch, i.e., in a direction of a diameter of the winch from a rotating axis of the winch drum.

According to the present invention, as the boom support frames such as rear frames have openings in such a manner that the smaller-diameter portions of the winches pass through the openings, the strength of the rear frames can be enhanced and thereby a load bearing or supporting force can be strengthened highly.

### BRIEF DESCRIPTION OF THE DRAWINGS

FIGS. 1A and 1B are views of a rotating frame of a telescopic boom type crane according to an embodiment of the present invention, and FIGS. 1A and 1B are a plan view thereof and a side view thereof respectively;

FIGS. 2A-2C are views of a structure of a detachable frame connected to a rear frame of FIGS. 1A and 1B, and FIGS. 2A-2C are a rear view thereof, a side view thereof, and a bottom plan view thereof respectively;

FIG. 3 is a side view of the rotating frame in a state of connecting the rear frame with the detachable frame;

FIG. 4 is a side view of the rotating frame in a state of mounting a main winch and an auxiliary winch;

FIG. 5 is an explanatory view showing an arrangement of the detachable frame and the rear frame to a winch;

FIG. 6 is a side view of the rotating frame according to a second embodiment of the present invention;

FIG. 7 is a side view of the rotating frame according to a third embodiment of the present invention; and

FIG. 8 is a side view of a travelling type crane.

### DESCRIPTION OF THE PREFERRED EMBODIMENTS

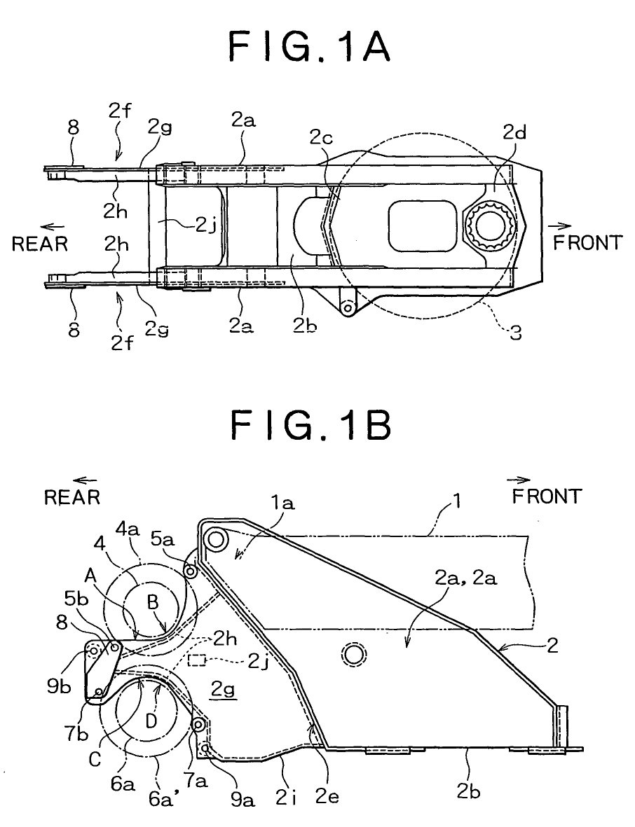

Preferred embodiments of the present invention are described in detail below with reference to the attached FIGS. 1-7. The present invention is not restricted only to such embodiments.

FIGS. 1A and 1B are a plan view and a side view, respectively, showing a rotating frame of a telescopic boom type crane in a traveling working machine according to an embodiment of the present invention.

With reference to FIG. 1B, a description will now be given of portions related to the present invention. The reference numeral 1 denotes a telescopic boom and the numeral 2 denotes a rotating frame to which a base end portion 1a of the telescopic boom 1 is attached. Devices are mounted on the rotating frame 2 to constitute an upper rotating body. The upper rotating body is mounted rotatably on a lower traveling body which is provided with a moving means such as a crawler.

The rotating frame 2 comprises a pair of boom support frames 2a, 2a bottom plate 2b, and a pair of front and rear reinforcing frames 2c, 2d.

The pair of boom support frames 2a, 2a (hereinafter may be referred to simply as support frames) are spacedly disposed right and left in parallel with each other in such a manner as sandwich the boom end portion 1a therebetween. As shown in the figure, the frames 2a, 2a are each in a generally triangular shape in side view in which the rear side is inclined upward. The frames 2a, 2a may hereinafter be referred to as “A” frames.

The bottom plate 2b is provided between lower surface sides of the support frames 2a, 2a.

The pair of front and rear reinforcing frames 2c, 2d are mounted bridgewise between both support frames 2a, 2a at front portions of the support frames.

A rotating motor mounting seat 3 is provided on the reinforcing frame 2d, and a pinion gear of a rotating motor (not shown) and a ring gear provided on a lower traveling body side are in mesh with each other. A swing bearing (not shown) is mounted on lower surface sides of the reinforcing frames 2c and 2d through the bottom plate 2b. A load on the upper rotating body side is transmitted through the swing bearing to the lower traveling body side.

A pair of rear frames 2g, 2g which are each constituted by a plate, are formed integrally and backwards at a rear end portion 2e of the boom support frame 2a.

The rear frames 2g, 2g are formed convexly backward and are reinforced by a reinforcing frame 2h.

Bosses 5a and 5b for mounting a main winch 4 are provided at upper front and rear positions of the rear frames 2g, 2g. Likewise, bosses 7a and 7b for mounting an auxiliary winch 6 are provided at lower front and rear positions of the rear frames 2g, 2g. Further, in each of the rear frames 2g, bosses 9a and 9b for the connection of a detachable frame 10 to be described later are disposed respectively near the lower side of the boss 7a and near the rear side of the boss 5b.

Cutout portions A are formed in upper edges of the rear frames 2g, 2g and the main winch 4 is disposed therein. The cutout portions A are formed outside in the vehicle width direction of flanges 4a of the main winch 4 and arcuately along a part of an outer periphery surface B of a decelerator in the main winch 4.

Further, cutout portions C are formed in lower edges of the rear frames 2g, 2g and the auxiliary winch 6 is disposed in the cutout portions C. The cutout portions C are formed outside in the vehicle width direction of flanges (large-diameter portions) 6a′ of the auxiliary winch 6 (outside in an axial direction of a drum of the winch) and arcuately along a part of an outer periphery surface (a small-diameter portion) D of a decelerator in the auxiliary winch 6.

The numeral 2i denotes a reinforcing rib which reinforces a lower surface portion of each of the rear frames 2g, 2g and numeral 2j denotes an intermediate beam which connects intermediate portions of the rear frames 2g, 2g in the vehicle width direction. Numeral 8 denotes a reinforcing plate which straddles the bosses 5b and 7b. Thus, a winch is mounted on a rear portion of the rotating frame 2.

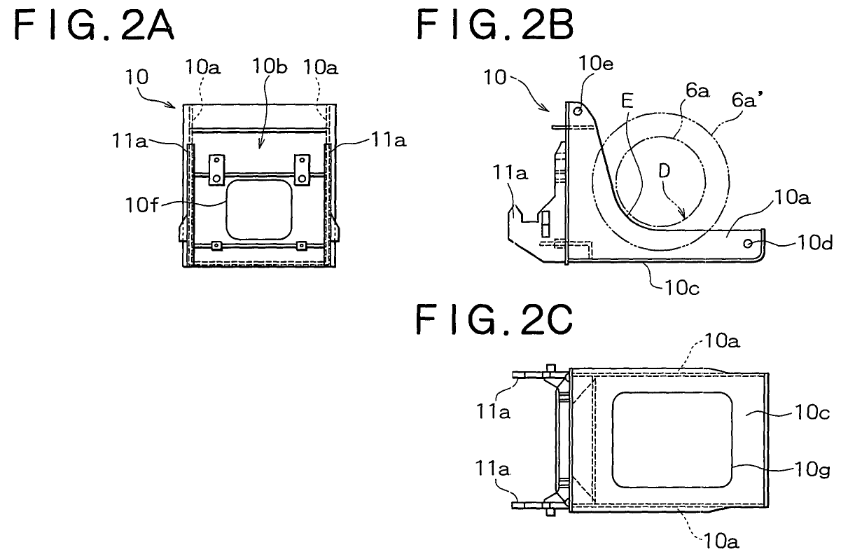

FIGS. 2A to 2C illustrate the construction of a detachable frame which is connected detachably to lower portions of rear ends of the rear frames 2g, 2g of which FIG. 2A is a rear view thereof, FIG. 2B is a side view thereof, and FIG. 2C is a bottom view thereof. The rear frames 2g, 2g and the detachable frame 10 constitute rear portions of the boom support frames.

In those figures, the detachable frame 10 comprises a pair of side plates 10a, 10a each formed in L shape and disposed in the longitudinal direction, a rear plate 10b, 10b connected so as to close a rear side of the side plates 10a, 10a and a bottom plate 10c connected so as to close a bottom side of the side plates 10a. Further, counterweight mounting portions 11a, 11a for mounting a counterweight (hereinafter may be referred to as “CW”) (not shown) are fixed to rear ends of the side plates 10a.

Cutout portions E are formed in upper edges of both side plates 10a so as to confront the cutout portions C (see FIG. 1B) of the rear frames 2g when the detachable frame 10 is connected to the rear frames 2g. The cutout portions E are formed arcuately so as to extend partially along the outer periphery surface D (a small-diameter portion) of the decelerator of the auxiliary winch 6.

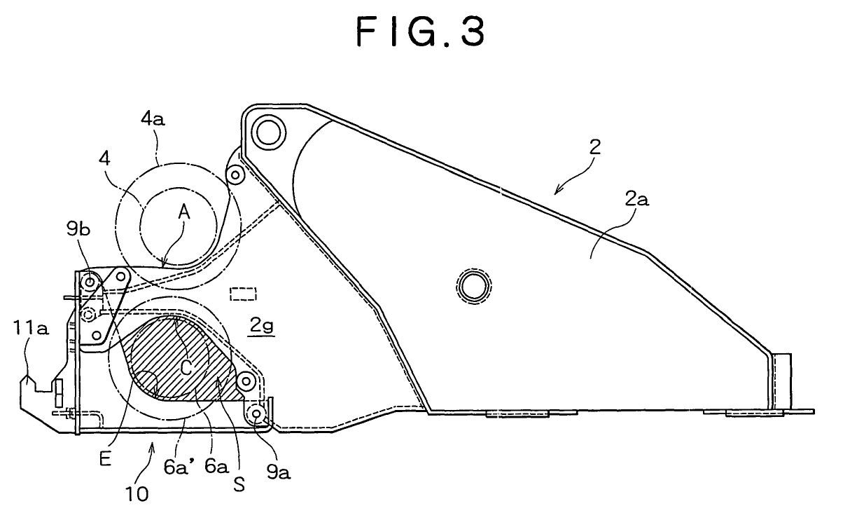

That is, when the cutout portions E of the detachable frame 10 and the cutout portions C of the rear frame 2g are positioned so as to sandwich the decelerator outer periphery surface D of the auxiliary winch 6 from both above and below, they define generally circular winch openings S (see FIG. 3) which will be described later.

A mounting hole 10d formed in each side plate 10a of the detachable frame 10 corresponds to the boss 9a shown in FIG. 1B and a mounting hole 10e formed in each side plate 10a corresponds to the boss 9b shown in the same figure.

Numeral 10f denotes an opening for winch inspection which opening is formed in the rear plate 10b, and numeral 10g denotes an opening for winch inspection which opening is formed in the bottom plate 10c.

FIG. 3 shows a connected state of the detachable frame 10 to the rear frames 2g.

In the following description, the same components as in FIGS. 1A, 1B and FIGS. 2A to 2C will be identified by the same reference numerals and explanations thereof will be omitted.

In FIG. 3, the mounting holes 10d and 10e of the detachable frame 10 are made corresponding to the bosses 9a and 9b, respectively, then in this state a connecting pin is inserted in each set of mounting hole and boss, whereby the detachable frame is connected to and rendered integral with the rear frames 2g.

With CW not mounted, if brackets for mounting the main and auxiliary winches are strengthened so as to withstand the weights and tensions of the winches, it is possible to support the rotating frame even in the absence of rear frames 2g. On the other hand, with CW mounted, the provision of rear frames 2g permits a construction which can support the rotating frame 2 while reducing the weight of the rotating frame. Thus, the rear frames 2g are superior in point of function thereof.

It is preferable that each rear frame 2g be made equal in width to each boom support frame 2a at a rear portion of the frame 2a. This is because of being efficient in ensuring high strength and rigidity. There also may be adopted a construction wherein each rear frame 2g be made smaller in width than each support frame 2a and extend backward from an inside position, or conversely each rear frame 2g may be widened outwards. In this case, it is preferable to adopt a construction wherein the connection of each rear frame 2g with the support frame 2a is formed in a tapered shape.

In this embodiment, the rear and lower ends of the rear frames 2g are integrally connected with the detachable frame 10. Besides, the detachable frame 10 extends along a part of a portion D (see FIG. 1B), i.e., along the outer periphery surface of the decelerator of the auxiliary winch 6, which portion D lies outside in the vehicle width direction of a winch drum 6a of the auxiliary winch 6 and has a diameter smaller than the winch flange diameter. The rear frames 2g and the detachable frame 10 thus rendered integral with each other as one unit can form winch openings S which permit passage therethrough of only the decelerator portion of the auxiliary winch 6. As a result, the strength of the rear frames 2g is enhanced and it is possible to strengthen the load bearing force.

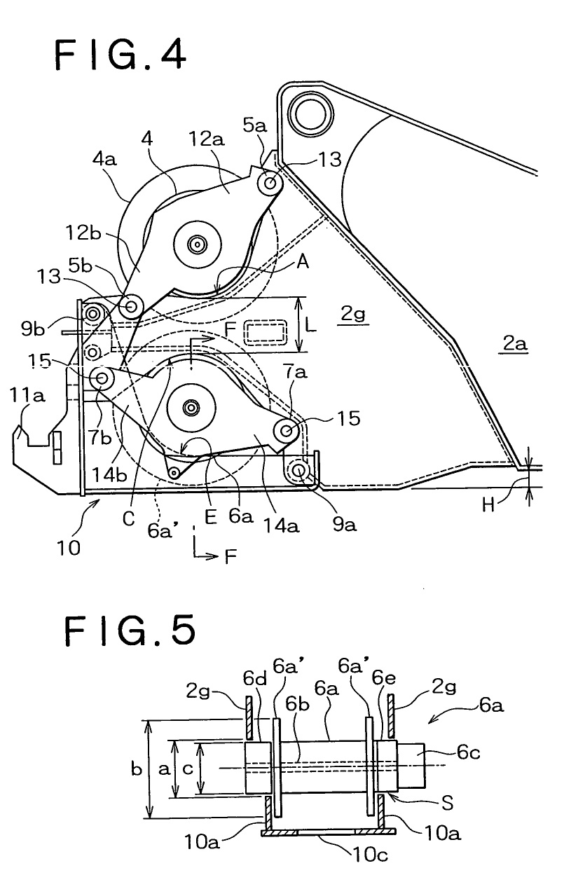

FIG. 4 shows a state in which the main winch 4 and the auxiliary winch 6 are mounted to the rear frames 2g thus enhanced in strength.

On each of both sides of the flanges 4a of the main winch 4, there are provided mounting brackets 12a and 12b in diametrically opposite directions. One of the brackets 12 and 12b is connected to the boss 5a of each of the rear frames 2g through a connecting pin 13, while the other bracket is connected the boss 5b through a connecting pin 13.

In this state, each cutout portion A passes the smaller-diameter portion than the flange diameter outside the associated flange 4a, ensuring a sufficient distance L between it and the underlying cutout portion C.

Also as to the auxiliary winch 6, like the main winch 4, there are provided mounting brackets 14a and 14b. One of the brackets 14a and 14b is connected to the boss 7a of each of the rear frames 2g through a connecting pin 15, while the other bracket is connected to the boss 7b through a connecting pin 15.

Accordingly, as noted above, the auxiliary winch 6 is disposed in a sandwiched state between the cutout portions C of the rear frames 2g and the cutout portions E of the detachable frame 10.

The rear frames 2g are extended with a difference in height, H, relative to the boom support frames 2a, whereby the longitudinal length of each rear frame 2g can be enlarged. As a result, the main winch 4 and the auxiliary winch 6 can be disposed in two vertical stages without any forcibleness.

FIG. 5 is a view as seen in the arrowed direction F-F in FIG. 4, showing a mounted state of the auxiliary winch 6 schematically.

A winch generally comprises a winch drum, a decelerator, a hydraulic motor, a clutch, and a brake device, which are generally unitized. On the other hand, the rear frames which support the winch are usually provided in a shorter width than the overall length of a rotary shaft of the winch in order to attain the reduction of weight and in order to dispose the rear frames in proximity to the winch drum to bear the load on the winch drum positively and efficiently.

In FIG. 5, the auxiliary winch 6 incorporates a planetary reduction mechanism and a multiple disk type wet brake device. The auxiliary winch 6 comprises a winch drum 6a, a drum shaft 6b, a hydraulic motor 6c, clutch device 6d, and a reduction mechanism 6e.

The winch drum 6a has flanges 6a′ as largest diameter portions in its axial direction. The drum shaft 6b is disposed along the axis of the drum 6a. The hydraulic motor 6c causes the drum shaft 6b to rotate. The clutch device 6d makes switching between transmission and non-transmission of an output of the hydraulic motor 6c with respect to the drum shaft. The reduction mechanism 6e decelerates the output of the motor 6c and transmits the decelerated output to the winch drum 6a.

End portions of the rear frames 2g are positioned outside the flanges (large-diameter portions) 6a′ of the winch drum 6a in its axial direction and in opposition to upper outer periphery surfaces of the clutch device 6d and the reduction mechanism 6e. The drum 6a is mounted inside between the frames 2g. The clutch device 6d and the reduction mechanism 6e which form smaller-diameter portions than the flanges 6a′ are positioned on a radially central side with respect to the outside diameter of the flanges 6a′.

On the other hand, the side plates 10a of the detachable frame 10 are positioned outside the drum 6a and in opposition to lower outer periphery surfaces (small-diameter portions) of the clutch device 6d and the reduction mechanisms 6e.

More specifically, as shown in FIG. 5, given that a minimum size of the winch opening S is “a” and the diameters of the large- and small-diameter portions of the winch are b and c, respectively, their values are set so as to satisfy the relation of b>a≧c.

According to this construction, the strength of each rear frame 2g can be enhanced in comparison with the conventional construction in which a larger opening than the flange diameter of the drum 6a is formed in each rear frame.

Thus, in the rotating frame 2 are formed openings S running along a smaller-diameter portion than the maximum-diameter portion of the winch mounted inside the frame.

By “mounting inside” is meant a state in which a part of the winch is disposed substantially within the width of the pair of right and left boom support frames 2a which are main strength enhancing members of the rotating frame 2. In the embodiment illustrated in FIGS. 1A and 1B, a winch drum is positioned between the rear frames 2g of the rotating frame 2 and the motor driver and the decelerator are disposed at outwardly projecting positions of the boom. The winch drum constitutes an axial part of the winch.

In the above embodiment, reference has been made to a constructional example in which the decelerator 6e is mounted within the range of the winch drum 6a provided a part thereof projects axially from the winch drum 6a and constitutes a small-diameter portion), and an output shaft of the hydraulic motor 6c is connected to the decelerator 6e, with these components being unitized. According to this construction, as described above, the detachable frame 10 can be detached from the rear frames 2g.

On the other hand, in the case where the winch drum, the decelerator and the hydraulic motor are connected in series and there is installed a winch capable of being divided between the winch drum and the reduction mechanism, the rear frames may each be provided with a mere winch opening of a circular shape without provision of the detachable frame.

In this case, winch components are installed inside the rear frames 2g from, for example, an opening above the rear frames and are then assembled through the openings S to constitute the winch.

In this embodiment, a gap is formed between each winch opening S and the winch 6. Of course, there may be adopted a modification in which an end portion of each rear frame 2g and the small-diameter portion of the winch are abutted against each other. In this case, the winch itself also functions as a strength enhancing member and therefore the rigidity can be enhanced to a greater extent. But also in this case the winch opening is set to satisfy the relation of b>a≧c.

There also may be adopted a construction wherein the mounting brackets 14a (see FIG. 4) are abutted against the cutout portions of the rear frames 2g and also against the side plates 10a of the detachable frame 10 to close the openings S. In this case, as is the case with the above, the winch can be allowed to function as a strength enhancing member. As a result, it is possible to enhance the rigidity to a greater extent.

Although in the above embodiment the winch drum is installed inside the rear frames 2g, this constitutes no limitation. For example, the clutch device, decelerator and motor as winch components may be installed inside the rear frames 2g and the winch drum may be disposed outside the rear frames.

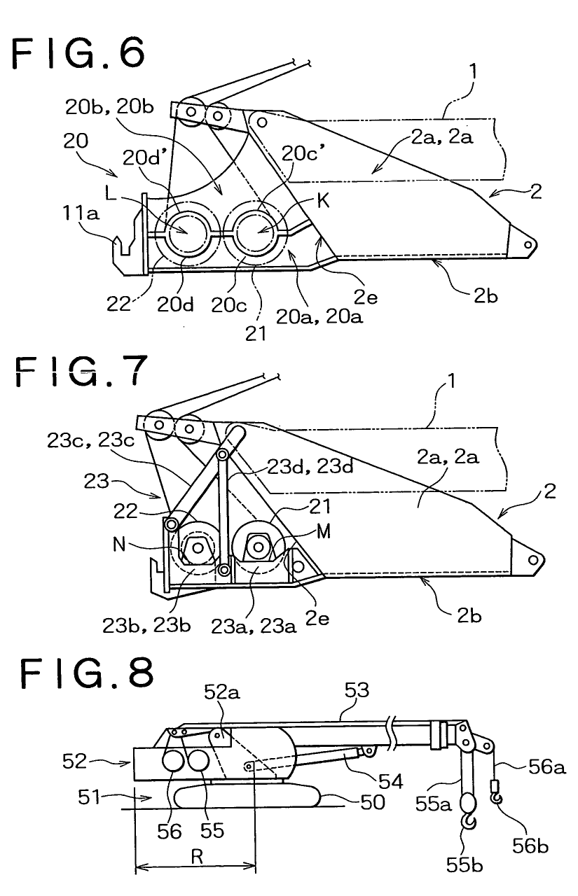

FIG. 6 illustrates a second embodiment of the present invention, in which winches are disposed at front and rear positions of rear frames.

In this embodiment, rear frames 20 extend backward from rear ends 2e of a pair of boom support frames 2a. The rear frames (rear portions of the boom support frames) 20 are constituted by vertically combining a pair of lower rear frames 20a with a pair of upper rear frames 20b (only this-side ones of the lower and upper rear frames are shown, namely only each one of the frames shown on this paper is drawn).

Cutout portions 20c and 20d are formed semicircularly in each of the lower rear frames 20a and cutout portions 20c′ and 20d′ are also formed semicircularly in each of the upper rear frames 20b. The cutout portions 20c and 20d are respectively opposed to the cutout portions 20c′ and 20d′, and when these cutout portions are combined together, there are formed circular openings K and L.

A main winch 21 and an auxiliary winch 22 are disposed in the openings K and L, respectively.

The cutout portions 20c and 20c′ are formed along an outer periphery surface (a small-diameter portion) of an accelerator of the main winch 21, while the cutout portions 20d and 20d′ are formed along an outer periphery surface (a small-diameter portion) of an accelerator of the auxiliary winch 22. The lower rear frames 20a are connected detachably to the rear ends of the boom support frames 2a and also to the upper rear frames 20b.

According to this arrangement, even in the case of large-diameter winches difficult to be disposed coaxially in the transverse direction of the machine body and difficult to be disposed vertically, they can be disposed in the rear frames compactly.

The rear frames 20a and 20b are constituted detachably for the boom support frames 2a. Therefore, not only it is possible to remove the rear frames at the time of moving the crane, thereby shortening the overall length of the crane, but also it is possible to lighten the weight of the crane.

FIG. 7 illustrates a third embodiment of the present invention, in which winches are disposed at front and rear positions of rear frames and the rear frames which support the winches are connected to a pair of boom support frames 2a through links.

In the same figure, rear frames 23 extend backward from the boom support frames 2a. The rear frames (rear portions of the boom support frames) 23 are mainly composed of a pair of rear frames 23a, another pair of rear frames 23b connected to and behind the rear frames 23a, (only this-side ones of these frames are shown), a pair of links 23c and a pair of links 23d, (only this-side ones of these links are shown), for connecting the rear frames to the boom support frames 2a.

A concave cutout portion M is formed in each rear frame 23a and a concave cutout portion N is also formed in each rear frame 23b. A main winch 21 and an auxiliary winch 22 are disposed in the cutout portions M and N, respectively.

The links 23c and 23d function to not only support rear and front portions of the rear frames 23b but also close upper-side openings of the cutout portions M and N.

The cutout portions M of the rear frames 23a are formed along a part of an outer periphery surface (a small-diameter portion) of a decelerator of the main winch 21, while the cutout portions N of the rear frames 23b are formed along a part of an outer periphery portion (small-diameter portion) of a decelerator of the auxiliary winch 22.

In this case, as in the previous second embodiment, even large-diameter winches difficult to be disposed coaxially in the transverse direction of the machine body and also difficult to be disposed vertically can be disposed compactly in the rear frames.

The rear frames 23a are connected detachably to the boom support frames 2a. The rear frames 23b are connected detachably to the rear frames 23a. Therefore, the main winch 21 and the auxiliary winch 22 can be disposed each independently in the rear frames.

It is preferable to adopt a construction wherein the rear frames 23a and 23b are connected through links 23c and 23d to the boom support frames 2a. This construction is advantageous in that even if a torsion is transmitted through the winches to the rear frames 23a and 23b, the torsion can be absorbed at the connections.

As shown in each of the above embodiments if the winch mounting portions at the rear portions of the boom support frames are constructed in a dividable manner through winch openings, it is possible to form openings which permit easy insertion and removal of the winches installed inside the frames. Consequently, the working efficiency in mounting the winches to the rear portions of the boom support frames can be improved remarkably.

Although in the above embodiments there are shown constructions wherein winch mounting portions can be divided in the longitudinal direction, there may be adopted a construction wherein winch mounting portions can be divided in the transverse direction, insofar as it is possible to span openings. It is also possible to adopt a construction wherein only a part of each side face is formed detachably. In the third embodiment shown in FIG. 7, winch drum flanges, when seen sideways, are installed inside while being enclosed with rear frames and links on the frames which are connected to the rear portions of the boom support frames. In this case, the motor and the decelerator are mounted sideways and outwardly projectingly from each winch drum.

The traveling working machine of the present invention is applicable not only to the telescopic boom type crane described in the above embodiments but also to a latticed boom type crane, an excavator, or a pile driver.

According to a basic construction of the present invention, as set forth above, in a traveling working machine wherein an upper rotating body having winches and a boom capable of rising and lowering is mounted on a lower traveling body, a pair of right and left boom support frames which pivotally support both right and left sides of rear ends of the boom are formed in a rotating frame of the upper rotating body, and the winches are supported while being mounted axially partially within rear portions of the boom support frames, the rear portions of the boom support frames are formed with openings as cutout portions along smaller-diameter portions than maximum-diameter portions of the winch portions mounted inside the frame rear portions.

With this construction, it is possible to improve the strength of the rotating frame to a greater extent and thereby strengthen the load bearing force.

In the present invention, the rear portions of the boom support frames may be constituted by fixed frames and detachable frames connected detachably to the fixed frames, and both such fixed and detachable frames are connected together to form the foregoing openings.

According to this construction, if the detachable frames are detached, even a winch whose overall length is larger than the rear frame width can be attached to the rear portion of the rotating frame in a simple manner.

It is preferable to adopt a construction wherein in a mutually connected state of both fixed and detachable frames, openings of a generally circular shape are formed along the outer peripheries of winches' small-diameter portions.

According to this construction it is possible to minimize the area of each opening and enhance the strength of the rear portions of the boom support frames effectively.

In the present invention, winches can be disposed vertically and also can be disposed longitudinally at the rear portions of the boom support frames.

In the vertical arrangement, since the strength of the rear portions of the boom support frames can be enhanced by the foregoing basic construction, it is possible to dispose winches vertically at the rear portions of the boom support frames and hence possible to shorten the rear end radius.

In the longitudinal arrangement, winches of a large diameter incapable of being disposed coaxially in the transverse direction of the machine body can be disposed at the rear portions of the boom support frames compactly.

Further, the boom support frames whose predetermined strength is ensured by the foregoing predetermined strength can be provided with counterweight mounting portions for mounting a counterweight.

The counterweight mounting portions can be formed at the rear ends of the boom support frames because the strength of the rear portions of the boom support frames is enhanced by the foregoing basic construction.

Although the invention has been described with reference to the preferred embodiments in the attached figures, it is noted that equivalents may be employed and substitutions made herein without from the scope of the invention as recited in the claims.

I claim:

1. A traveling working machine comprising:
a lower traveling body;
an upper rotating body mounted rotatably on said lower traveling body, said upper rotating body having a rotating frame and winches;
a boom mounted on said upper rotating body so as to be capable of rising and lowering; and
a pair of right and left boom support frames formed in said rotating frame to pivotally support both right and left sides of a rear end portion of said boom, axial portions of the winches, including maximum-diameter portions of the winches, being mounted inside rear portions of said boom support frames, said boom support frames having openings formed by being cut out along smaller-diameter portions of the winches than said maximum-diameter portions.

2. A traveling working machine according to claim 1, wherein the rear portions of said boom support frames each comprise a fixed frame and a detachable frame connected detachably to said fixed frame, and said openings are formed when both said fixed and detachable frames are connected together.

3. A traveling working machine according to claim 2, wherein in a mutually connected state of both said fixed and detachable frames, said openings which have a generally circular shape are formed along outer peripheries of the smaller-diameter portions of said winches.

4. A traveling working machine according to claim 1, wherein said winches are disposed vertically at the rear portions of said boom support frames.

5. A traveling working machine according to claim 1, wherein said winches are disposed longitudinally at the rear portions of said boom support frames.

6. A traveling working machine according to claim 1, further comprising:
counterweight mounting portions for mounting a counterweight, said counterweight mounting portions being provided at the rear portions of said boom support frames.
